(19) United States
(12) Patent Application Publication
(10) Pub. No.: US 2007/0127050 A1
(43) Pub. Date: Jun. 7, 2007

(54) Image forming apparatus, image forming method, and computer program product

(76) Inventors: Nobuyuki Iwata, Kanagawa (JP); Naohiko Kubo, Tokyo (JP); Hiroya Uruta, Tokyo (JP); Takahiro Hirakawa, kanagawa (JP); Naruhiko Ogasawara, Chiba (JP)

Correspondence Address: DICKSTEIN SHAPIRO LLP, 1825 EYE STREET NW, Washington, DC, 20006-5403, US

(21) Appl. No.: 11/605,433

(22) Filed: Nov. 29, 2006

(30) Foreign Application Priority Data
Dec. 2, 2005 (JP) 2005-349458

(51) Int. Cl. G06F 3/12

(52) U.S. Cl. 358/1.13; 358/1.15

(57) ABSTRACT

When it is determined that an image cannot be formed from an image data under an image formation condition, a display input controller accepts an input of a replaced image formation condition. An image formation unit forms an image from the image data under the replaced image formation condition. A storage processor stores the image data and the image formation condition in a storage unit when the image is formed by the image formation unit. When reforming an image from stored image data, the image formation unit forms the image under stored image formation condition.

### CROSS-REFERENCE TO RELATED APPLICATIONS

The present document incorporates by reference the entire contents of Japanese priority document, 2005-349458 filed in Japan on Dec. 2, 2005.

### BACKGROUND OF THE INVENTION

1. Field of the Invention

The present invention generally relates to a technology for forming an image based on input image data, storing the image data, and reforming an image based stored image data.

2. Description of the Related Art

Some of conventional image forming apparatuses incorporate a function of temporarily accumulating (storing) data to be printed (hereinafter, “print data”) in the image forming apparatus and reprinting the print data in the image forming apparatus. For example, Japanese Patent Application Laid-Open No. 2003-276281 discloses a printer (image forming apparatus) that includes a printing unit capable of printing print data after temporarily accumulating the print data, and also includes a controller for setting a print mode in the printing unit according to a printing method requested by a user when the print data is reprinted. More specifically, in this patent document, when the print data accumulated is to be reprinted, the printer displays possible printing methods by referring to information for accumulated documents such as paper size and to printer information such as a tray and a paper type. When the printing method is entered by the user, the printer sets the print mode corresponding to the printing method entered and performs a printing process.

However, the conventional image forming apparatuses have an ordinary operation such that the print data (image data to be formed) is accumulated in the image forming apparatus according to an instruction from an external information processor, and thereafter, the print data accumulated is reprinted through operation of the image forming apparatus. When the print data is to be printed and accumulated but if printing cannot be performed under a desired print condition (image formation condition), the print condition is changed to execute printing. At that time, however, the print data and the print condition sometimes cannot be accumulated.

### SUMMARY OF THE INVENTION

It is an object of the present invention to at least partially solve the problems in the conventional technology.

An image forming apparatus according to one aspect of the present invention includes a determination unit that determines whether an image formation is possible from input image data under an input image formation condition; a display input controller that, when it is determined that the image formation is not possible from the image data under the image formation condition by the determination unit, accepts an input of a replaced image formation condition with which the image formation is possible from a display input device; an image formation unit that, when it is determined that the image formation is not possible from the input image data under the input image formation condition by the determination unit, forms an image from the image data under the replaced image formation condition; and a storage processor that stores the image data and the image formation condition in a storage unit when the image is formed by the image formation unit. When reforming an image from stored image data, the image formation unit forms the image under stored image formation condition.

An image forming method according to another aspect of the present invention includes determining whether an image formation is possible from input image data under an input image formation condition; accepting, when it is determined that the image formation is not possible from the image data under the image formation condition at the determining, an input of a replaced image formation condition with which the image formation is possible from a display input device; forming, when it is determined that the image formation is not possible from the input image data under the input image formation condition at the determining, an image from the image data under the replaced image formation condition; and storing the image data and the image formation condition in a storage unit when the image is formed at the forming. When reforming an image from stored image data, the forming includes forming the image under stored image formation condition.

A computer program product according to still anther aspect of the present invention includes a computer usable medium having computer readable program codes embodied in the medium that when executed cause a computer to execute determining whether an image formation is possible from input image data under an input image formation condition; accepting, when it is determined that the image formation is not possible from the image data under the image formation condition at the determining, an input of a replaced image formation condition with which the image formation is possible from a display input device; forming, when it is determined that the image formation is not possible from the input image data under the input image formation condition at the determining, an image from the image data under the replaced image formation condition; and storing the image data and the image formation condition in a storage unit when the image is formed at the forming. When reforming an image from stored image data, the forming includes forming the image under stored image formation condition.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a relationship between a printer according to a first embodiment of the present invention and an external device,

FIG. 2 is a schematic of a hardware configuration of the printer according to the first embodiment;

FIG. 3 is a block diagram of a functional configuration of the printer according to the first embodiment;

FIG. 4 is a conceptual schematic of how to transmit print job data from a computer to the printer according to the first embodiment;

FIG. 5 is a schematic of an example of a data content stored in a storage unit;

FIG. 6 is a flowchart of the procedure of a printing process in the printer according to the first embodiment;

FIG. 7 is a schematic of an example of a data content stored in the storage unit when a replaced print condition is accepted from a user, according to the first embodiment;

FIG. 8 is a flowchart of the procedure of a printing process in a printer according to a second embodiment of the present invention;

FIG. 9 is a schematic of an example of a data content stored in a storage unit when a replaced print condition is accepted from a user, according to the second embodiment;

FIG. 10 is a flowchart of the procedure of a printing and storing process in a printer according to a third embodiment of the present invention;

FIG. 11 is a flowchart of the procedure of a reprinting process in the printer according to the third embodiment;

FIG. 12 is a schematic of a print-condition selection screen displayed on an operation panel;

FIG. 13 is a flowchart of the procedure of a reprinting process in a printer according to a fourth embodiment of the present invention;

FIG. 14 is a block diagram of a functional configuration of a printer according to a fifth embodiment of the present invention;

FIG. 15 is a flowchart of the procedure of a reprinting process in the printer according to the fifth embodiment;

FIG. 16 is a block diagram of a functional configuration of a printer according to a sixth embodiment of the present invention;

FIG. 17 is a schematic of an example of a data content stored in a condition-item storage unit;

FIG. 18 is a schematic of a specific-print-condition specification screen displayed on the operation panel;

FIG. 19 is a flowchart of the procedure of a printing process in the printer according to the sixth embodiment; and

FIG. 20 is a schematic of an example of a data content stored in a storage unit when the printing process is executed under the replaced print condition.

### DETAILED DESCRIPTION OF THE PREFERRED EMBODIMENTS

Exemplary embodiments of the present invention are explained in detail below with reference to the accompanying drawings. The following embodiments show an example in which the image forming apparatus according to the present invention is applied to a printer. However, the present invention is applicable not only to the printer but also to each function of a copier, a facsimile, and a scanner, or to a multifunction peripheral that accommodates a plurality of functions such as a copier, a facsimile, and a printer in one housing to perform image processing.

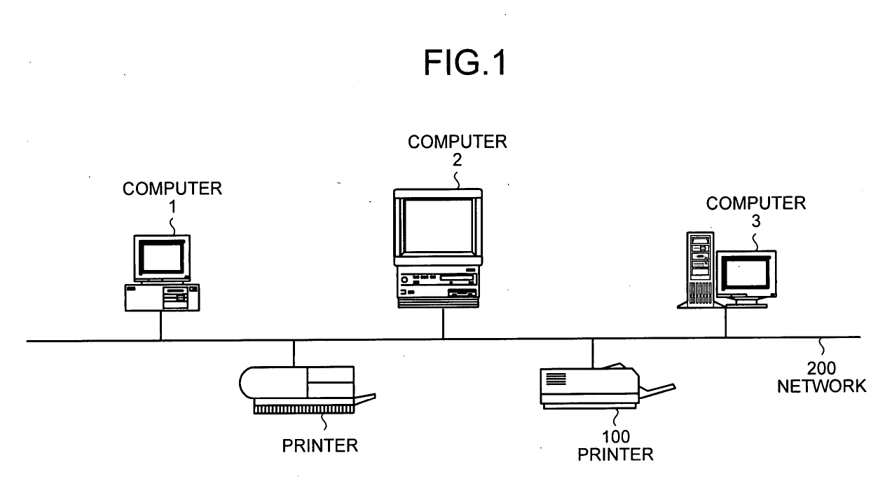

A printer according to a first embodiment of the present invention receives data to be printed and a print request from an external device, and prints out the data received on a recording paper. As shown in FIG. 1, a printer 100 according to the first embodiment is connected to a plurality of computers such as a computer 1, a computer 2, and a computer 3 (hereinafter, “computer”) through a network 200 such as the Internet and a Local Area Network (LAN).

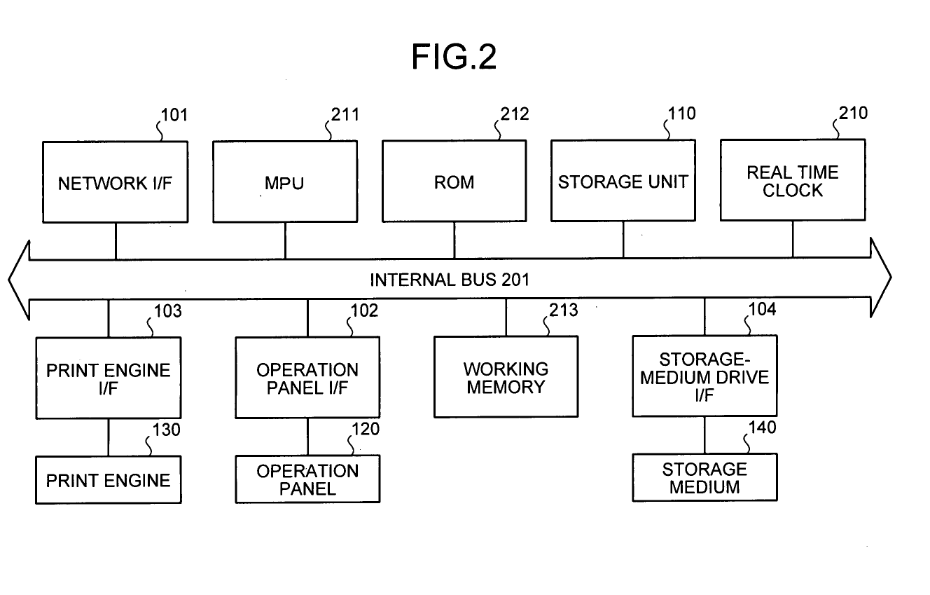

As shown in FIG. 2, the printer 100 includes a network Interface (I/F) 101, a Micro Processing Unit (MPU) 211, a Read Only Memory (ROM) 212, a storage unit 110 such as a Hard Disk Drive (HDD), a real time clock 210, a print engine I/F 103 connected to a print engine 130, an operation panel I/F 102 connected to an operation panel 120, a working memory 213 such as Random Access Memory (RAM), and a storage-medium drive I/F 104 connected to a storage medium 140, these of which communicate with one another through an internal bus 201.

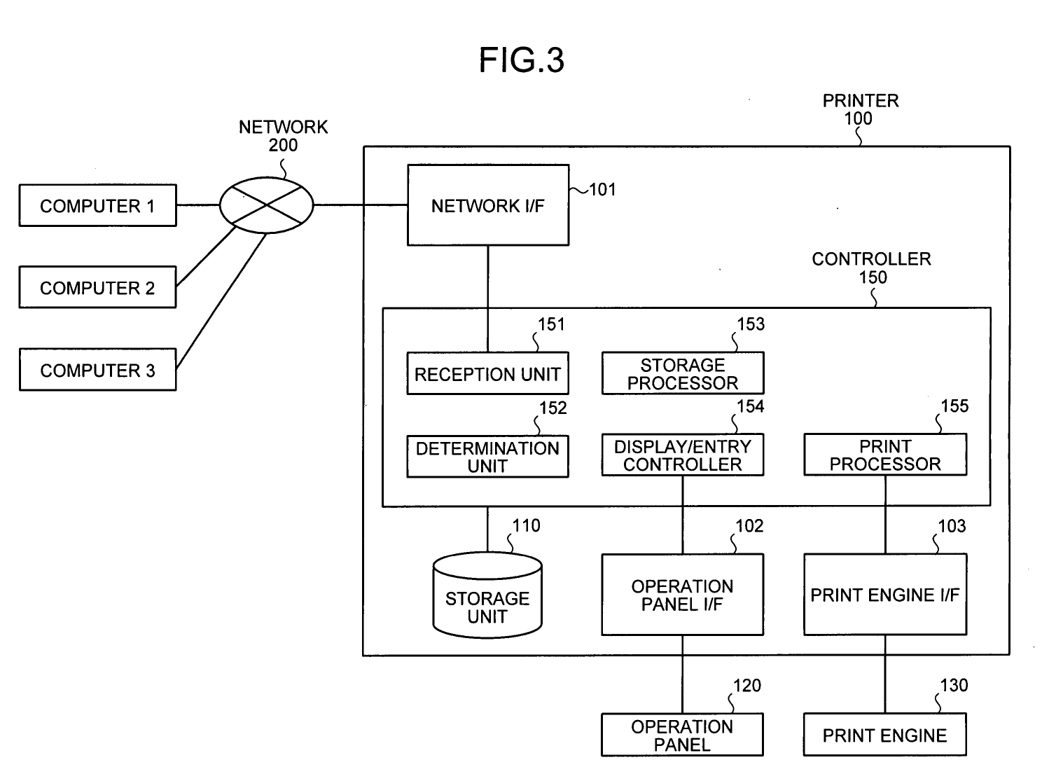

As shown in FIG. 3, the printer 100 is connected to a plurality of computers through the network 200, and mainly includes the network I/F 101, a controller 150, the storage unit 110, the operation panel 120, the operation panel I/F 102, the print engine 130, and the print engine I/F 103.

Each of the computers instructs printing of a document or the like created by an application and specifies a print condition, generates print job data containing print data for the document and the print condition, and transmits the print job data to the printer.

The network I/F 101 controls data transmission/reception through a network such as a network board.

The operation panel 120 displays an input screen to the user, and the user enters data through the input screen displayed and operation keys.

The print engine 130 outputs an image formed by a print processor 155 to a transfer paper through the print engine I/F 103.

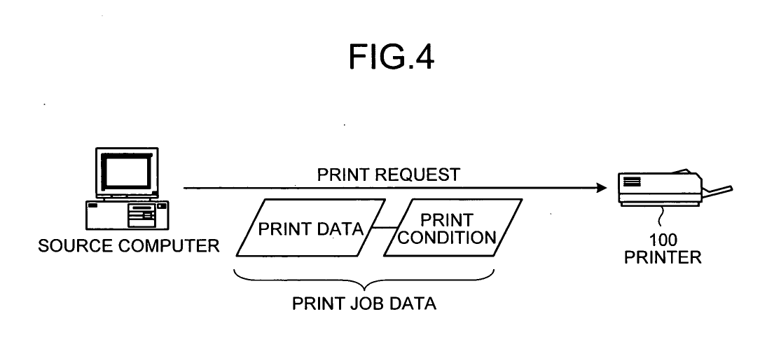

The storage unit 110 is a storage medium such as HDD and memory, and stores the print data and print condition extracted from the print job data transmitted from the computer. The print job data mentioned here indicates data as a unit of single print job, which contains the print condition such as a paper size, specification of duplex printing, and specification of a stapling process; the print data; and various types of commands such as specification of page layout. As shown in FIG. 4, a computer as source transmits the print job data containing the print data and the print condition to the printer 100 to make a print request.

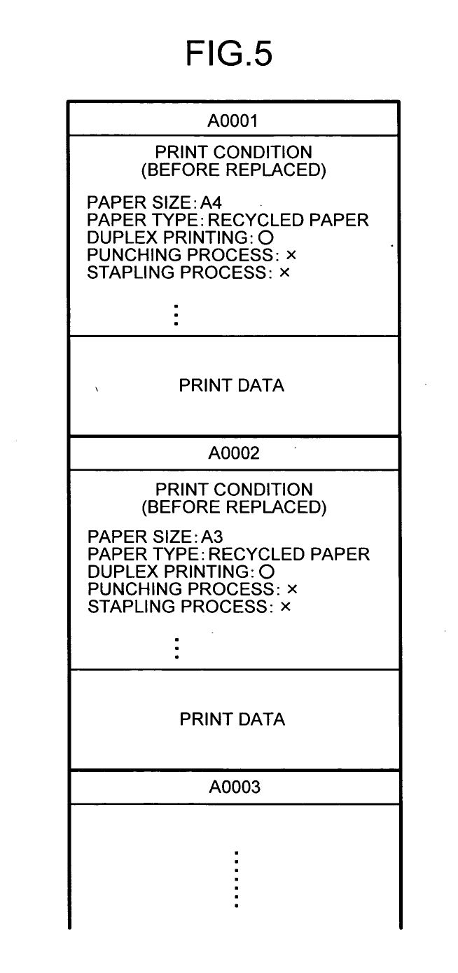

As shown in FIG. 5, the storage unit 110 stores identification data for identifying print data, a print condition, and print data, which are associated with one another. Specifically, the print condition includes a paper size, a paper type, presence or absence of a duplex printing function, presence or absence of a punching process, and presence or absence of a stapling process. And the print data is printed out on a recording paper or the like. More specifically, the storage unit 110 first stores the identification data (A0001), and then, the print condition indicating print condition items and their set contents such as paper size: A4; paper type: recycled paper; duplex printing: available (“O”); punching process: not available (“x”); and stapling process: not available (“x”), and last stores the print data.

The detail of the controller 150 is explained below. The controller 150 controls the whole of the printer 100, and mainly includes a reception unit 151, a determination unit 152, a storage processor 153, a display input controller 154, and the print processor 155.

The reception unit 151 receives, via the network I/F 101, the print job data containing the print condition and the print data and also receives the print request for the print data transmitted from the computer connected through the network 200.

The determination unit 152 compares the print condition contained in the print job data with the current status of the printer 100 and the function of the printer 100, to determine whether the print data also contained in the print job data can be printed. For example, there is a case where the printer 100 is out of A4-size paper although the paper size in the print condition is set to A4 size. Similarly to this case, there are also cases where the printer 100 happens to be not ready and the printer 100 has no stapling function although the stapling process is set in the print condition, and in either the cases, the determination unit 152 determines that printing is impossible. When it is determined that the print data cannot be printed under the print condition contained in the print job data, the determination unit 152 also determines whether the print data can be printed under a replaced print condition with another one (hereinafter, “replaced print condition”), which is changed by the user and accepted by the display input controller 154 explained later.

The storage processor 153 interprets the print job data received from the computer via the network, extracts the print condition and the print data from the print job data, and assigns the identification data to the print condition and the print data extracted, making a pair, to be stored in the storage unit 110.

The display input controller 154 displays a screen on the operation panel 120, and controls input through the operation panel 120 via the operation panel I/F 102. When the determination unit 152 determines that the print data cannot be printed by the print condition received, the display input controller 154 displays this effect on the operation panel 120. Furthermore, the display input controller 154 accepts input of a replaced print condition that is changed by the user through the operation panel 120. The display input controller 154 also accepts input of a reprint request of the print data stored in the storage unit 110 from the user. The replaced print condition mentioned here indicates a print condition that is determined by the user as being printable and entered to the printer without using the computer.

The print processor 155 bitmaps the print data contained in the print job data based on the print condition also contained in the print job data, to form image data. The print processor 155 sends the image data to the print engine 130 through the print engine I/F 103 to perform a printing process of the print data. Furthermore, when the print data is printed under the replaced print condition accepted by the display input controller 154, and when the print data stored in the storage unit 110 is reprinted, the print processor 155 also forms the image data to perform the printing process.

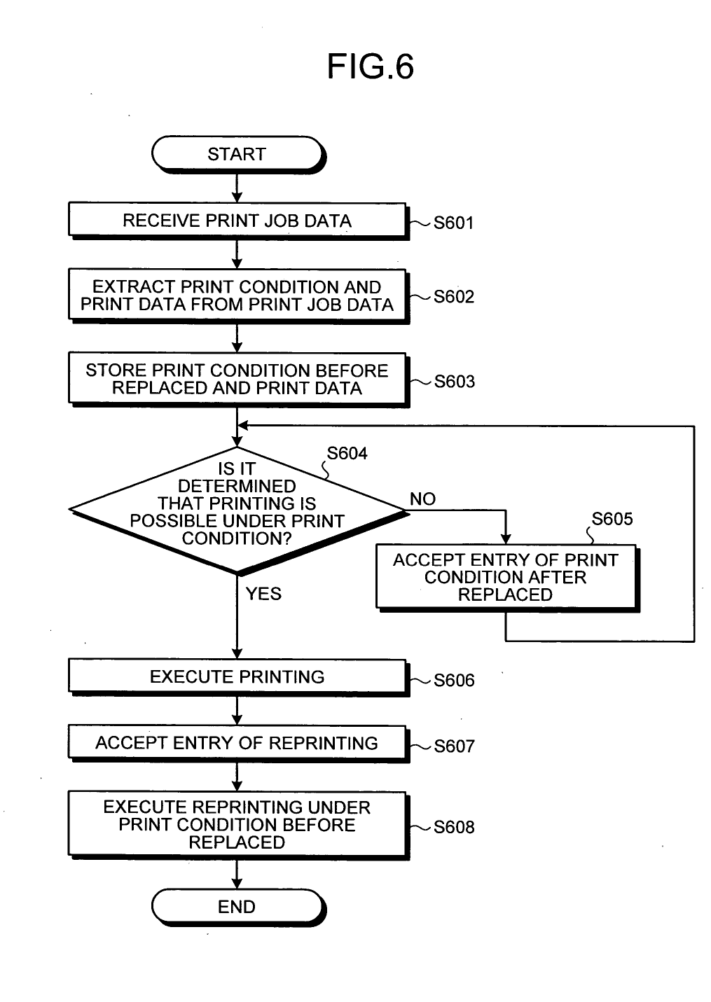

The printing process in the printer according to the first embodiment configured in the above manner is explained below with reference to FIG. 6.

First, the reception unit 151 receives the print job data containing the print condition and the print data from the computer via the network I/F 101 (step S601). Then, the storage processor 153 extracts the print condition and the print data from the print job data received by the reception unit 151 (step S602). The storage processor 153 stores the print condition (before replaced with another one) (hereinafter, “printing condition before replaced”) and the print data extracted, in the storage unit 110 (step S603).

The determination unit 152 determines whether the print data contained in the print job data can be printed under the print condition also contained in the print job data (step S604). When it is determined that the print data cannot be printed under the print condition contained in the print job data (step S604, No), the display input controller 154 displays a message that the printing is impossible on the operation panel 120, and accepts input of a replaced print condition which is changed by the user, through the operation panel 120 (step S605). The determination unit 152 again determines whether the print data can be printed under the replaced print condition accepted by the display input controller 154 (step S604).

On the other hand, when the determination unit 152 determines that the print data can be printed under the print condition contained in the print job data or under the replaced print condition entered at step S605 (step S604, Yes), the print processor 155 executes the printing process of the print data based on the print condition determined as being printable (step S606).

When the display input controller 154 accepts input of a reprint request of the print data stored in the storage unit 110 from the user (step S607), the print processor 155 executes a reprinting process of the print data based on the print condition, i.e. the print condition before replaced, which is stored at step S603, received from the reception unit 151 (step S608).

As explained above, in the printer 100 according to the first embodiment, the storage processor 153 stores the print condition before replaced in the storage unit 110 when the print processor 155 prints the print data under the replaced print condition. Therefore, even if the printing and storage of the print data are performed concurrently, the printer 100 can easily print the data under the print condition originally desired upon reprinting, and this enables improved usability. For example, even if the desired printing cannot be performed because the print condition of the printer 100 is not prepared at a particular time like in the case where the printer 100 is out of paper of paper size specified, the printing can be easily performed under the print condition originally desired by storing the print condition before replaced, when reprinting is performed afterward and if the paper of the paper size specified is supplied.

Even if the print data is printed under the replaced print condition, the printer according to the first embodiment stores the print condition received from the computer, i.e. the print condition before replaced, in the storage unit. When reprinting is performed, the printing is performed under the print condition before replaced. However, a printer according to a second embodiment of the present invention stores the replaced print condition in the storage unit when the print data is printed under the replaced print condition, and performs the printing under the replaced print condition even when reprinting is performed.

The relationship between the printer according to the second embodiment and an external device and the hardware configuration of the printer according to the second embodiment are the same as these of the printer according to the first embodiment, and therefore, explanation thereof is omitted.

The functional configuration of the printer according to the second embodiment is explained below with reference to FIG. 3 because the functional configuration thereof is the same as the configuration of the printer according to the first embodiment. However, the configurations and functions of the network I/F 101; the operation panel 120; the operation panel I/F 102; the print engine 130; the print engine I/F 103; and the reception unit 151, the determination unit 152, the display input controller 154, and the print processor 155 in the controller 150 are the same as these of the printer according to the first embodiment, and therefore, explanation thereof is omitted.

The storage unit 110 is the storage medium such as HDD and memory, and stores the print condition and print data extracted from the print job data transmitted from the computer. Furthermore, when the input of a replaced print condition is accepted from the user, the storage unit 110 stores the replaced print condition.

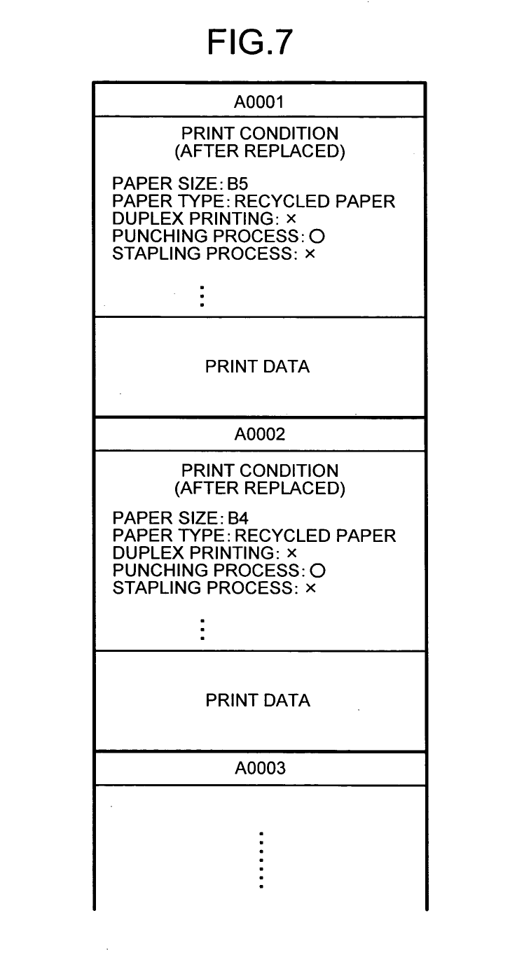

As shown in FIG. 7, the storage unit 110 stores identification data for identifying print data, a replaced print condition, and print data, which are associated with one another. Specifically, the replaced print condition includes the paper size, the paper type, the presence or absence of the duplex printing function, the presence or absence of the punching process, and the presence or absence of the stapling process. And the print data is printed out on a recording paper or the like. More specifically, the storage unit 110 first stores the identification data (A0001), and then, the print condition indicating print condition items and their set contents such as paper size: B5; paper type: recycled paper; duplex printing: not available; punching process: available; and stapling process: not available, and last stores the print data.

The storage processor 153 interprets the print job data received from the computer via the network, extracts the print condition and the print data from the print job data, and assigns the identification data to the print condition and the print data extracted, making a pair, to be stored in the storage unit 110. Furthermore, when the input of a replaced print condition is accepted from the user, the storage processor 153 stores the replaced print condition in the storage unit 110.

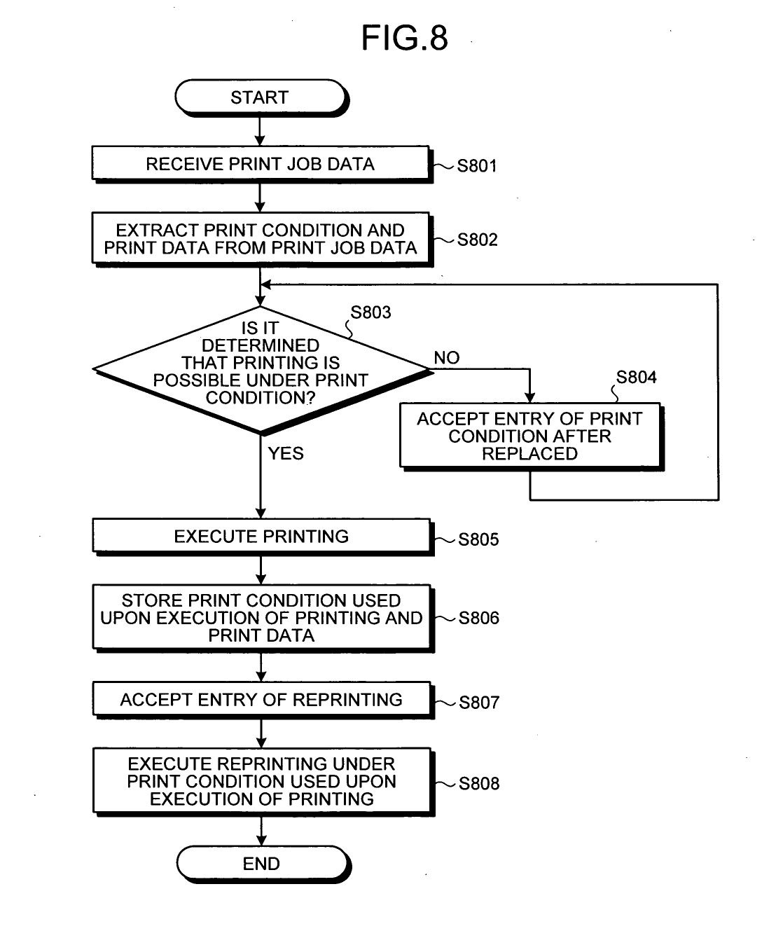

The printing process in the printer according to the second embodiment configured in the above manner is explained below with reference to FIG. 8.

First, the reception unit 151 receives the print job data containing the print condition and the print data from the computer via the network I/F 101 (step S801). Then, the storage processor 153 extracts the print condition and the print data from the print job data received by the reception unit 151 (step S802). The determination unit 152 determines whether the print data contained in the print job data can be printed under the print condition also contained in the print job data (step S803).

When it is determined that the print data cannot be printed under the print condition contained in the print job data (step S803, No), the display input controller 154 displays a message that the printing is impossible on the operation panel 120, and accepts input of a replaced print condition which is changed by the user, through the operation panel 120 (step S804). The determination unit 152 again determines whether the print data can be printed under the replaced print condition accepted by the display input controller 154 (step S803).

On the other hand, when it is determined that the print data can be printed under the print condition contained in the print job data or under the replaced print condition entered at step S804 (step S803, Yes), the print processor 155 executes the printing process of the print data based on the print condition determined as being printable (step S805).

The storage processor 153 stores the print condition used upon execution of the printing process at step S805 (the print condition received from the reception unit 151 or the replaced print condition accepted by the display input controller 154) and the print data in the storage unit 110 (step S806).

When the display input controller 154 accepts input of a reprint request for the print data stored in the storage unit 110 from the user (step S807), the print processor 155 executes the reprinting process of the print data based on the print condition which is stored in the storage unit 110 and used upon execution of the printing process at step S805 (step S808).

As explained above, in the printer 100 according to the second embodiment, when the print processor 155 prints the print data under the replaced print condition, the storage processor 153 stores the replaced print condition in the storage unit 110. Therefore, even if the printing and storage of the print data are performed concurrently, there is no need to replace the print condition with another one, the replacement being supposed to be required whenever the print condition does not match the printer 100 upon reprinting, thus improving the usability. For example, there is a case where the condition of the stapling process is set in the print condition before replaced although the printer 100 does not incorporate the stapling function. Even in this case, by storing the replaced print condition, the print data can be printed without replacing the print condition, which does not match the configuration of the printer 100, with another one upon reprinting. This enables reduction in trouble such that the print condition is again replaced.

The printer according to the first embodiment stores the print condition before replaced even if the print data is printed under the replaced print condition. The printer according to the second embodiment stores the replaced print condition when the print data is printed under the replaced print condition. However, a printer according to a third embodiment of the present invention stores the print condition before replaced and the replaced print condition when the print data is printed under the replaced print condition, and can select either the print condition before replaced or the replaced print condition when the print data is reprinted.

The relationship between the printer according to the third embodiment and an external device and the hardware configuration of the printer according to the third embodiment are the same as these of the printer according to the first embodiment, and therefore, explanation thereof is omitted.

The functional configuration of the printer according to the third embodiment is explained below with reference to FIG. 3 because the functional configuration is the same as the configuration of the printer according to the first embodiment. However, the configurations and functions of the network I/F 101; the operation panel 120; the operation panel I/F 102; the print engine 130; the print engine I/F 103; and the reception unit 151, the determination unit 152, the display input controller 154, and the print processor 155 in the controller 150 are the same as these of the printer according to the first embodiment, and therefore, explanation thereof is omitted.

The storage unit 110 is the storage medium such as HDD and memory, and stores the print data and the print condition extracted from the print job data transmitted from the computer. When the input of a replaced print condition is accepted from the user, the storage unit 110 stores the replaced print condition in addition to the print condition before replaced.

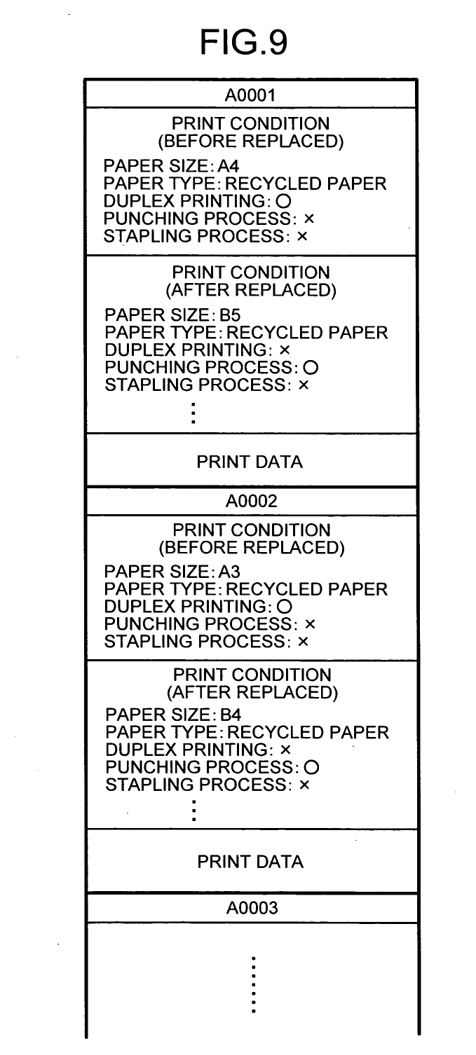

As shown in FIG. 9, the storage unit 110 stores identification data for identifying print data, a print condition before replaced and a replaced print condition, and print data, which are associated with one another. Specifically, the print conditions before and after replaced include the paper size, the paper type, the presence or absence of the duplex printing function, the presence or absence of the punching process, and the presence or absence of the stapling process. And the print data is printed out on a recording paper or the like. More specifically, the storage unit 110 first stores the identification data (A0001), and then, the print condition before replaced indicating print condition items and their set contents such as paper size: A4; paper type: recycled paper; duplex printing: available; punching process: not available; and stapling process: not available, the replaced print condition indicating print condition items and their set contents such as paper size: B5; paper type: recycled paper; duplex printing: not available; punching process: available; and stapling process: not available, and last stores the print data.

The storage processor 153 interprets the print job data received from the computer via the network, extracts the print condition and the print data from the print job data, and assigns the identification data to the print condition and the print data extracted, making a pair, to be stored in the storage unit 110. When the input of a replaced print condition is accepted from the user, the storage processor 153 stores the replaced print condition in the storage unit 110 in addition to the print condition before replaced. Furthermore, when the print data stored is to be reprinted, the storage processor 153 determines whether the replaced print condition is stored in the storage unit 110.

When the print condition before replaced and the replaced print condition are stored in the storage unit 110 in addition to the functions in the first embodiment, the display input controller 154 controls so as to display a print-condition selection screen for selecting either one of the print conditions on the operation panel 120. The display input controller 154 accepts the input of the print condition selected by the user through the operation panel 120.

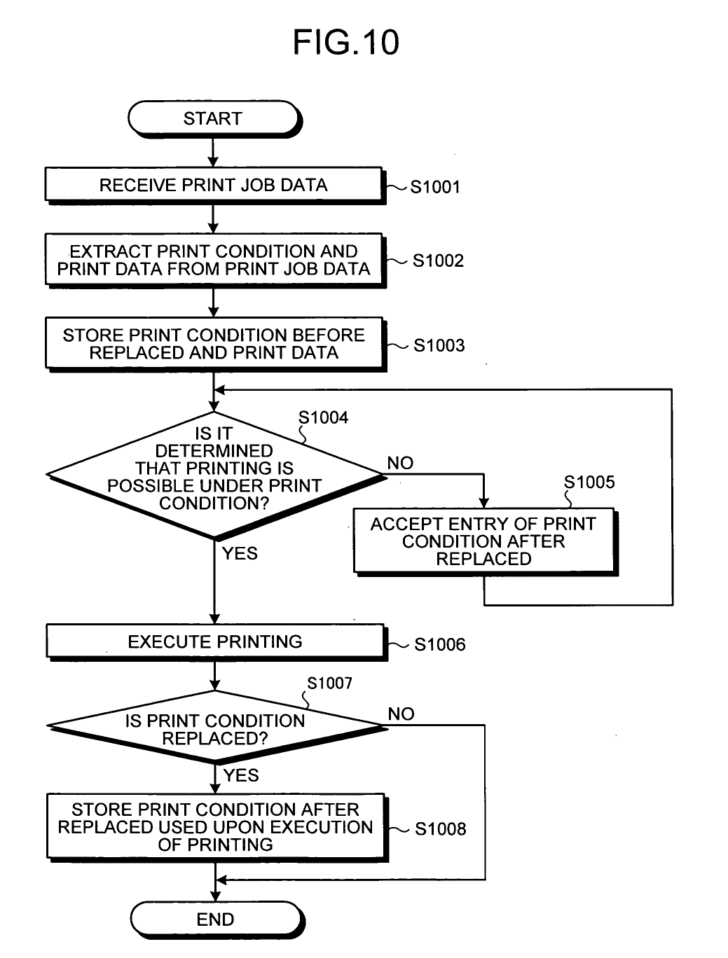

The printing and storing process in the printer according to the third embodiment configured in the above manner is explained below with reference to FIG. 10.

First, the reception unit 151 receives the print job data containing the print condition and the print data from the computer via the network I/F 101 (step S1001). Then, the storage processor 153 extracts the print condition and the print data from the print job data received from the reception unit 151 (step S1002). The storage processor 153 stores the print condition (before replaced) and the print data extracted in the storage unit 110 (step S1003).

The determination unit 152 determines whether the print data contained in the print job data can be printed under the print condition also contained in the print job data (step S1004). When it is determined that the print data cannot be printed under the print condition contained in the print job data (step S1004, No), the display input controller 154 displays a message that the printing is impossible on the operation panel 120, and accepts input of a replaced print condition which is changed by the user, through the operation panel 120 (step S1005). The determination unit 152 again determines whether the print data can be printed under the replaced print condition accepted by the display input controller 154 (step S1004).

On the other hand, when it is determined that the print data can be printed under the print condition contained in the print job data or under the replaced print condition entered at step S1005 (step S1004, Yes), the print processor 155 executes the printing process of the print data based on the print condition determined as being printable (step S1006).

The storage processor 153 determines whether the print condition is replaced with another one, that is, whether the print processor 155 executes the printing process based on the replaced print condition entered at step S1005 (step S1007). When it is determined that the printing process is not executed based on the replaced print condition (step S1007, No), the storage processor 153 exits the process as it is.

On the other hand, when it is determined that the printing process is executed based on the replaced print condition (step S1007, Yes), the storage processor 153 further stores the replaced print condition used upon execution of the printing process at step S1006, in the storage unit 110 (step S1008).

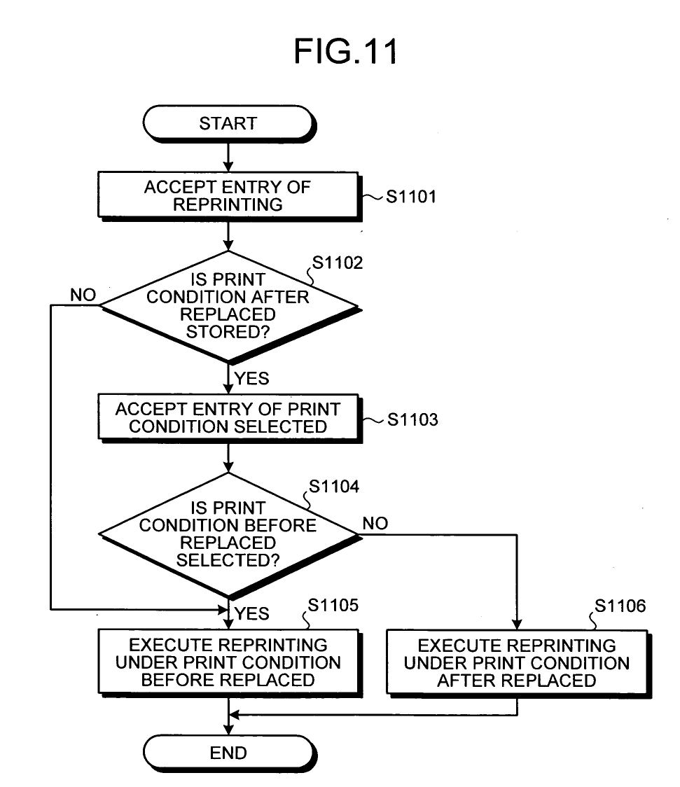

The reprinting process in the printer according to the third embodiment is explained below with reference to FIG. 11.

First, the display input controller 154 accepts input of a reprint request for the print data stored in the storage unit 110 from the user (step S1101). When the input of the reprint request is accepted, the storage processor 153 determines whether the replaced print condition is stored in the storage unit 110 (step S1102). When it is determined by the storage processor 153 that the replaced print condition is stored therein (step S1102, Yes), the display input controller 154 displays the print-condition selection screen on the operation panel 120, and accepts the input of either one of the print conditions selected by the user (step S1103).

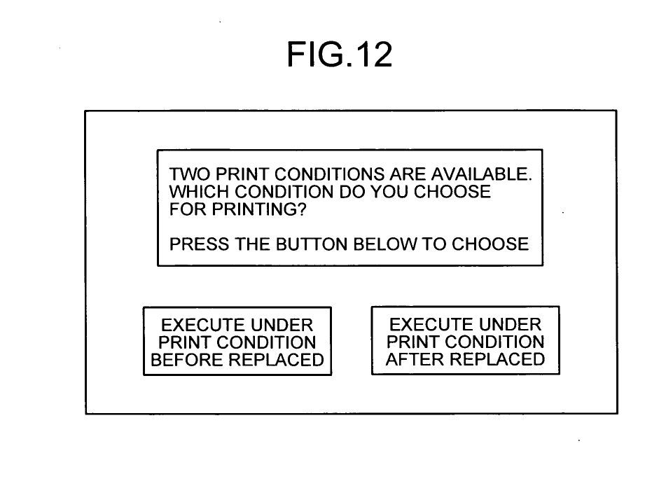

The print-condition selection screen mentioned here indicates a screen that displays a message that the print condition before replaced and the replaced print condition are stored in the storage unit 110 and that prompts the user to select either one of the print conditions for printing. As shown in FIG. 12, the screen displays a message that two print conditions are available, and that prompts the user to select either one of the print conditions for printing. There are buttons displayed on the screen, which can be used to select either the print condition before replaced or the replaced print condition. By pressing one of the buttons indicating execution of printing under the print condition before replaced, the print condition before replaced is selected, and by pressing the other button indicating execution of printing under the replaced print condition, the replaced print condition is selected.

Then, the print processor 155 determines whether the print condition selected by the user and accepted by the display input controller 154 is the print condition before replaced (step S1104). When the print condition selected by the user is not the print condition before replaced (step S1104, No), namely, when the replaced print condition is selected, the print processor 155 executes the reprinting process of the print data based on the replaced print condition (step S1106).

On the other hand, when the print condition selected by the user is the print condition before replaced (step S1104, Yes), the print processor 155 executes the reprinting process of the print data based on the print condition before replaced (step S1105). At step S1102, if it is determined by the storage processor 153 that the replaced print condition is not stored (step S1102, No), then this indicates that only the print condition before replaced is stored. Therefore, the print processor 155 executes the reprinting process of the print data based on the print condition before replaced without requesting the selection (step S1106).

As explained above, in the printer 100 according to the third embodiment, the storage processor 153 stores the print condition before replaced and the replaced print condition when the printing is performed under the replaced print condition. The display input controller 154 accepts the selection as to which of the print condition before replaced and the replaced print condition is used when the print data stored is reprinted. The print processor 155 prints the print data under either the print condition before replaced or the replaced print condition selected. Therefore, even if the printing and storage of the print data are performed concurrently, the user can select the print condition according to the situation upon reprinting, thus further improving the usability.

The printer according to the third embodiment stores the print condition before replaced and the replaced print condition when the print data is printed under the replaced print condition, and can select either the print condition before replaced or the replaced print condition when reprinting is performed. However, when reprinting is performed and if the reprinting is impossible under the print condition before replaced, a printer according to a fourth embodiment of the present invention performs the reprinting under the replaced print condition.

The relationship between the printer according to the fourth embodiment and an external device and the hardware configuration of the printer according to the fourth embodiment are the same as these of the printer according to the first embodiment, and therefore, explanation thereof is omitted.

The functional configuration of the printer according to the fourth embodiment is explained below with reference to FIG. 3 because the functional configuration is the same as the configuration of the printer according to the first embodiment. However, the configurations and functions of the network I/F 101; the operation panel 120; the operation panel I/F 102; the print engine 130; the print engine I/F 103; and the reception unit 151, the determination unit 152, the display input controller 154, and the print processor 155 in the controller 150 are the same as these of the printer according to the first embodiment, and therefore, explanation thereof is omitted. Furthermore, the configurations and functions of the storage unit 110 and the storage processor 153 are the same as these of the printer according to the third embodiment, and therefore, explanation thereof is omitted.

When the print data stored in the storage unit 110 is reprinted in addition to the functions according to the first embodiment, the determination unit 152 determines whether the print data can be printed under the print condition before replaced which is stored. Similarly, when reprinting is performed and if the replaced print condition is stored in the storage unit 110, the determination unit 152 determines whether the print data can be printed under the replaced print condition.

The printing and storing process and the reprinting process in the printer according to the fourth embodiment configured in the above manner are explained below. However, the printing and storing process in the printer according to the fourth embodiment is the same as the printing and storing process (FIG. 10) of the printer according to the third embodiment, and therefore, explanation thereof is omitted.

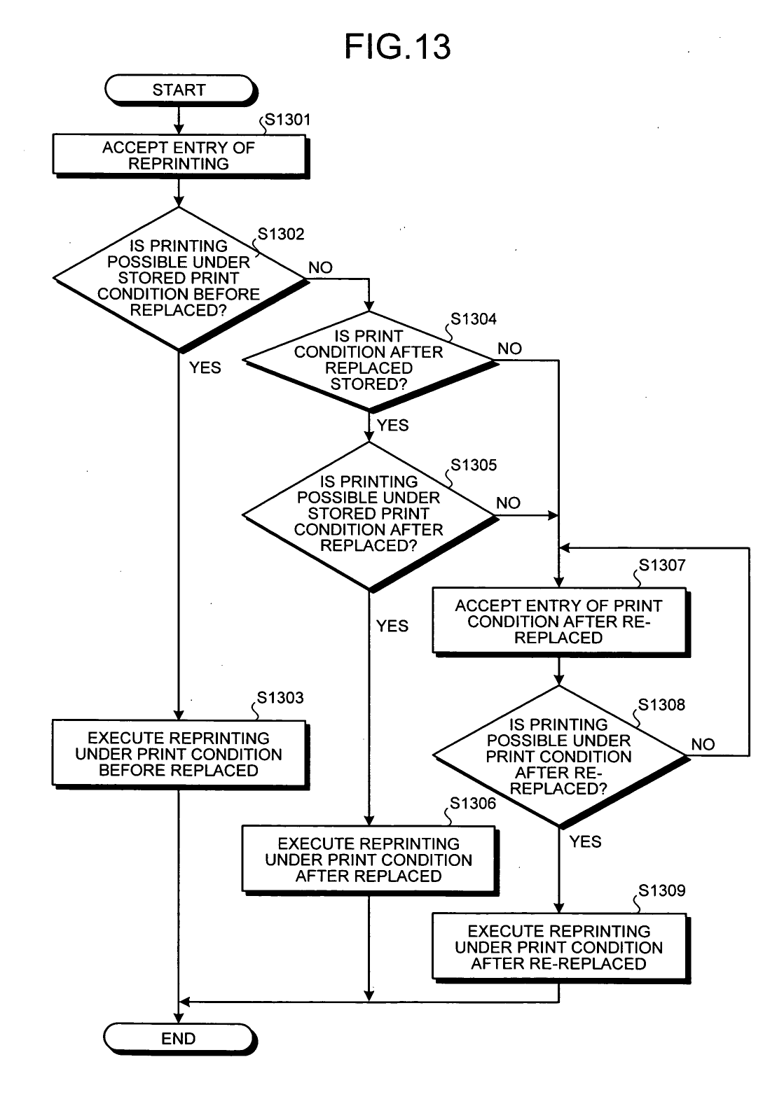

The reprinting process in the printer according to the fourth embodiment is explained below with reference to FIG. 13.

First, the display input controller 154 accepts input of a reprint request for the print data stored in the storage unit 110 from the user (step S1301). When the input of the reprint request is accepted, the determination unit 152 determines whether the print data stored in the storage unit 110 can be printed under the print condition before replaced also stored therein (step S1302). Then, when it is determined by the determination unit 152 that the print data can be printed under the print condition before replaced (step S1302, Yes), the print processor 155 executes the reprinting process of the print data based on the print condition before replaced (step S1303).

On the other hand, when it is determined by the determination unit 152 that the print data cannot be printed under the print condition before replaced (step S1302, No), the storage processor 153 determines whether the replaced print condition is stored in the storage unit 110 (step S1304). When it is determined by the storage processor 153 that the replaced print condition is stored therein (step S1304, Yes), the determination unit 152 determines whether the print data stored in the storage unit 110 can be printed under the replaced print condition also stored therein (step S1305). When it is determined by the determination unit 152 that the print data stored in the storage unit 110 can be printed under the replaced print condition (step S1305, Yes), the print processor 155 executes the reprinting process of the print data based on the replaced print condition (step S1306).

At step S1304, when it is determined by the storage processor 153 that the replaced print condition is not stored therein (step S1304, No), and at step S1305, when it is determined by the determination unit 152 that the print data cannot be printed under the replaced print condition (step S1305, No), the display input controller 154 displays a message that the printing is impossible on the operation panel 120, and accepts input of a print condition after re-replaced which is changed by the user through the operation panel 120 (step S1307). Then, the determination unit 152 determines whether the print data can be printed under the print condition after re-replaced accepted by the display input controller 154 (step S1308).

When it is determined by the determination unit 152 that the print data cannot be printed under the print condition after re-replaced (step S1308, No), the display input controller 154 accepts input of a print condition which is again changed and replaced with another one by the user through the operation panel 120 (step S1307).

On the other hand, when it is determined by the determination unit 152 that the print data can be printed under the print condition after re-replaced (step S1308, Yes), the print processor 155 executes the reprinting process of the print data based on the print condition after re-replaced (step S1309).

In the fourth embodiment, when the printing is impossible under the print condition before replaced, the printing is performed under the replaced print condition. Conversely, when the printing is impossible under the replaced print condition, the printing may be performed under the print condition before replaced.

As explained above, in the printer according to the fourth embodiment, the storage processor 153 stores the print condition before replaced and the replaced print condition when the printing is performed under the replaced print condition. The print processor 155 performs the printing under the replaced print condition when the print data stored is reprinted and if the printing is impossible under the print condition before replaced. Therefore, even if the printing and storage of the print data are performed concurrently, the printer 100 automatically selects the print condition upon reprinting, and this enables reduction in effort of the user to perform printing in a simple manner, and further improved usability.

In the printer according to the third embodiment, when the print data is printed under the replaced print condition, the print condition before replaced and the replaced print condition are stored. When reprinting is to be performed, either the print condition before replaced or the replaced print condition can be selected. In the printer according to the fourth embodiment, when reprinting is performed and if the reprinting is impossible under the print condition before replaced, the reprinting is performed under the replaced print condition. However, in a printer according to a fifth embodiment of the present invention, the user can select either one of the embodiments.

The relationship between the printer according to the fifth embodiment and an external device and the hardware configuration of the printer according to the fifth embodiment are the same as these of the printer according to the first embodiment, and therefore, explanation thereof is omitted.

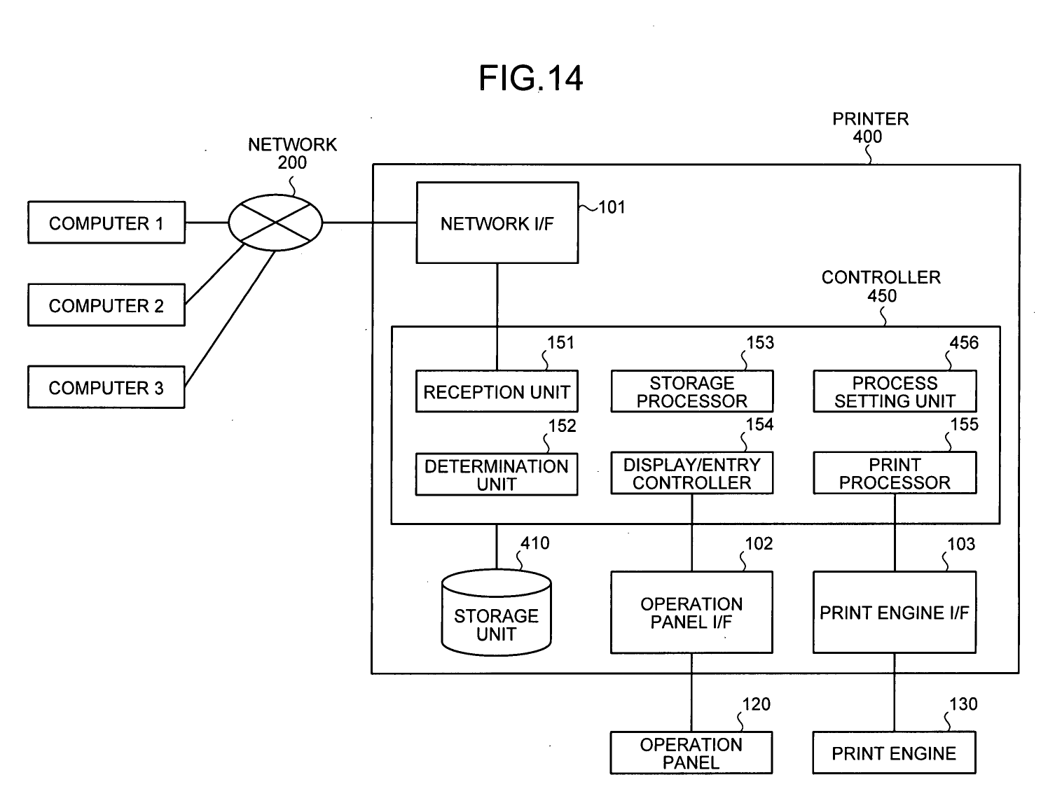

The functional configuration of the printer according to the fifth embodiment is explained below. As shown in FIG. 14, a printer 400 is connected to a plurality of computers via the network 200, and mainly includes the network I/F 101, a controller 450, a storage unit 410, the operation panel 120, the operation panel I/F 102, the print engine 130, and the print engine I/F 103.

However, the configurations and functions of the computers, the network I/F 101, the operation panel 120, the operation panel I/F 102, the print engine 130, and the print engine I/F 103 are the same as these of the printer according to the first embodiment, and therefore, explanation thereof is omitted.

The controller 450 controls the whole of the printer 400, and mainly includes the reception unit 151, the determination unit 152, the storage processor 153, the display input controller 154, the print processor 155, and a process setting unit 456. However, the configurations and functions of the reception unit 151 and the print processor 155 are the same as these of the printer according to the first embodiment. The configurations and functions of the storage processor 153 and the display input controller 154 are the same as these of the printer according to the third embodiment. The configuration and function of the determination unit 152 are the same as these of the printer according to the fourth embodiment. Therefore, explanation thereof is omitted.

When the print data stored in the storage unit 410 is to be reprinted, the process setting unit 456 of the controller 450 sets a process by being stored in the storage unit 410. Specifically, the process is obtained by selecting either a selected printing process or an automatic printing process. The selected printing process corresponds to the reprinting process according to the third embodiment for printing print data based on the print condition selected by the user. The automatic printing process corresponds to the reprinting process according to the fourth embodiment for printing print data based on the replaced print condition when the printing is impossible based on the print condition before replaced.

The storage unit 410 is the storage medium such as HDD and memory, and stores the print data and print condition extracted from the print job data transmitted from the computer. When input of a replaced print condition is accepted from the user, the storage unit 410 also stores the replaced print condition in addition to the print condition before replaced. Furthermore, the storage unit 410 stores the setting of the selected printing process or of the automatic printing process executed by the process setting unit 456.

The printing and storing process and the reprinting process in the printer according to the fifth embodiment configured in the above manner are explained below. However, the printing and storing process in the printer according to the fourth embodiment is the same as the printing and storing process (FIG. 10) in the printer according to the third embodiment, and therefore, explanation thereof is omitted.

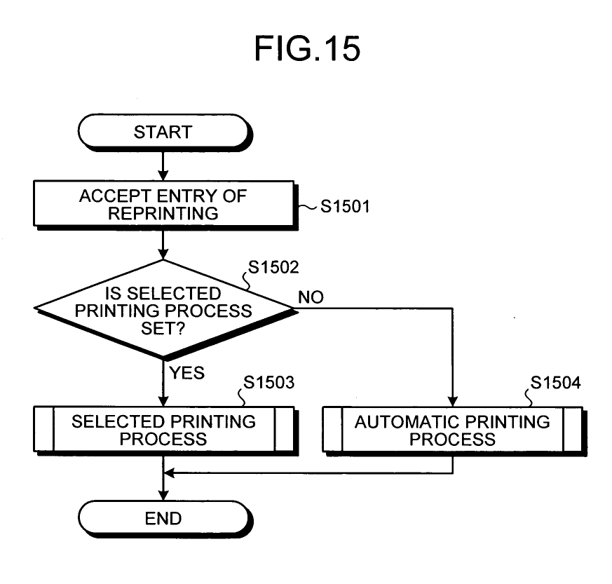

The reprinting process in the printer according to the fifth embodiment is explained below with reference to FIG. 15.

First, the display input controller 154 accepts input of a reprint request for the print data stored in the storage unit 410 from the user (step S1501). When the input of the reprint request is accepted, the print processor 155 determines whether the selected printing process is set in the storage unit 410 by the process setting unit 456 (step S1502).

When it is determined that the selected printing process is set in the storage unit 410 (step S1502, Yes), the print processor 155 executes the selected printing process. In other words, the print processor 155 executes the reprinting process according to the third embodiment as shown in FIG. 11 (step S1503).

On the other hand, when it is determined that the selected printing process is not set therein (step S1502, No), this indicates that the automatic printing process is set therein. Therefore, the print processor 155 executes the automatic printing process. In other words, the print processor 155 executes the reprinting process according to the fourth embodiment as shown in FIG. 13 (step S1504).

It is noted that the selected printing process or the automatic printing process is previously set by the user. The setting may be entered through the operation panel 120 of the printer 400. Alternatively, either one of the processes may be set by being initially contained in the print job data transmitted from the computer. In this case, information indicating that either one of the processes is set is added to the print job data as extension of print data command.

As explained above, in the printer according to the fifth embodiment, the process setting unit 456 sets either the selected printing process for printing based on the print condition selected by the user or the automatic printing process for printing based on the replaced print condition when the printing is impossible based on the print condition before replaced. When the print data is to be reprinted, the print processor 155 performs the printing based on the print condition selected by the user when the selected printing process is set, or performs the printing based on the replaced print condition when the automatic printing process is set and if the printing is impossible based on the print condition before replaced. In this manner, even if the printing and storage of the print data are performed concurrently, the user can further optionally select the print condition allowing for respective advantages of the print conditions upon reprinting, which enables further improvement of the usability.

The printer according to the first embodiment stores the print condition before replaced even if the print data is printed under the replaced print condition. The printer according to the second embodiment stores the replaced print condition when the print data is printed under the replaced print condition. However, a printer according to a sixth embodiment of the present invention stores the print condition before replaced and the replaced print condition when the print data is printed under the replaced print condition. And, when reprinting is performed, the printer according to the sixth embodiment performs the reprinting under the print condition before replaced for part of the print condition, and performs the reprinting under the replaced print condition for any print condition other than the part of the print condition.

The relationship between the printer according to the sixth embodiment and an external device and the hardware configuration of the printer according to the sixth embodiment are the same as these of the printer according to the first embodiment, and therefore, explanation thereof is omitted.

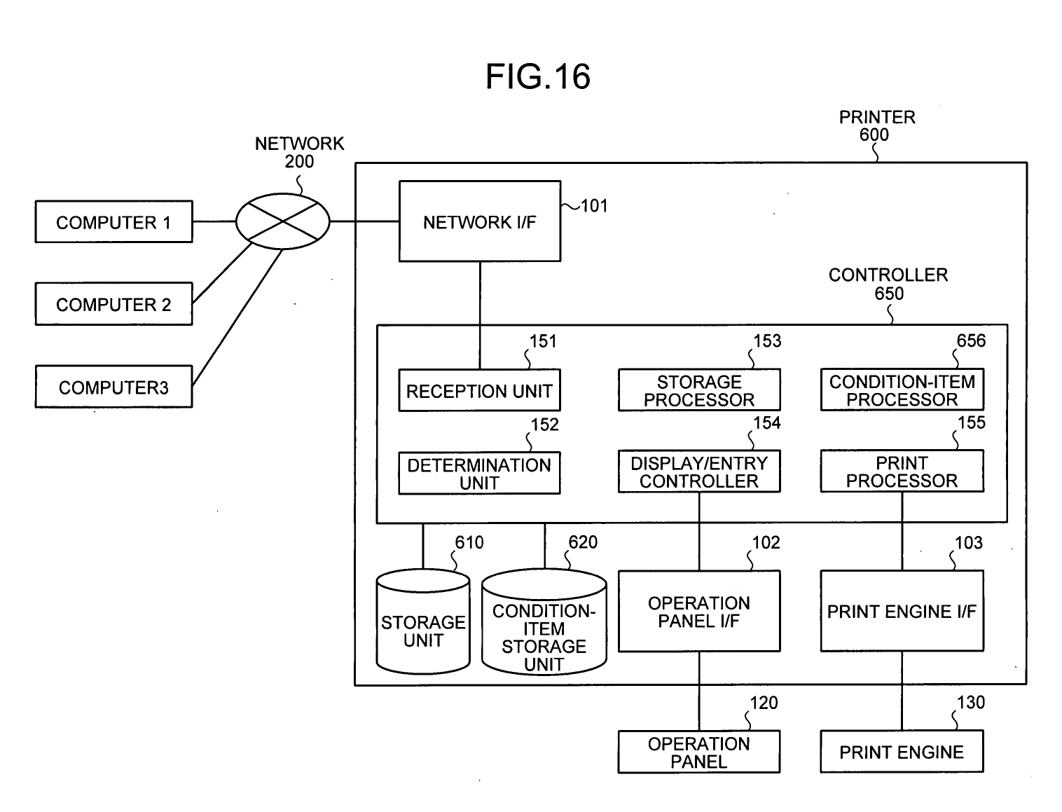

The functional configuration of the printer according to the sixth embodiment is explained below. As shown in FIG. 16, a printer 600 is connected to a plurality of computers through the network 200, and mainly includes the network I/F 101, a controller 650, a storage unit 610, a condition-item storage unit 620, the operation panel 120, the operation panel I/F 102, the print engine 130, and the print engine I/F 103.

However, the configurations and functions of the computers, the network I/F 101, the operation panel 120, the operation panel I/F 102, the print engine 130, and the print engine I/F 103 are the same as these of the printer according to the first embodiment, and therefore, explanation thereof is omitted.

The controller 650 controls the whole of the printer 600, and mainly includes the reception unit 151, the determination unit 152, the storage processor 153, the display input controller 154, the print processor 155, and a condition-item processor 656. However, the configurations and functions of the reception unit 151, the determination unit 152, the display input controller 154, and the print processor 155 are the same as these of the printer according to the first embodiment, and therefore, explanation thereof is omitted.

The condition-item storage unit 620 stores information as to which of a plurality of print condition items is specified by the user as a specific print condition. The print condition item mentioned here indicates a pair of print conditions in which each of individual print conditions is associated with a corresponding set content, such as paper size: A4, and duplex printing function: available. The specific print condition mentioned here indicates the one specified so as to store the print condition before replaced in the print condition item.

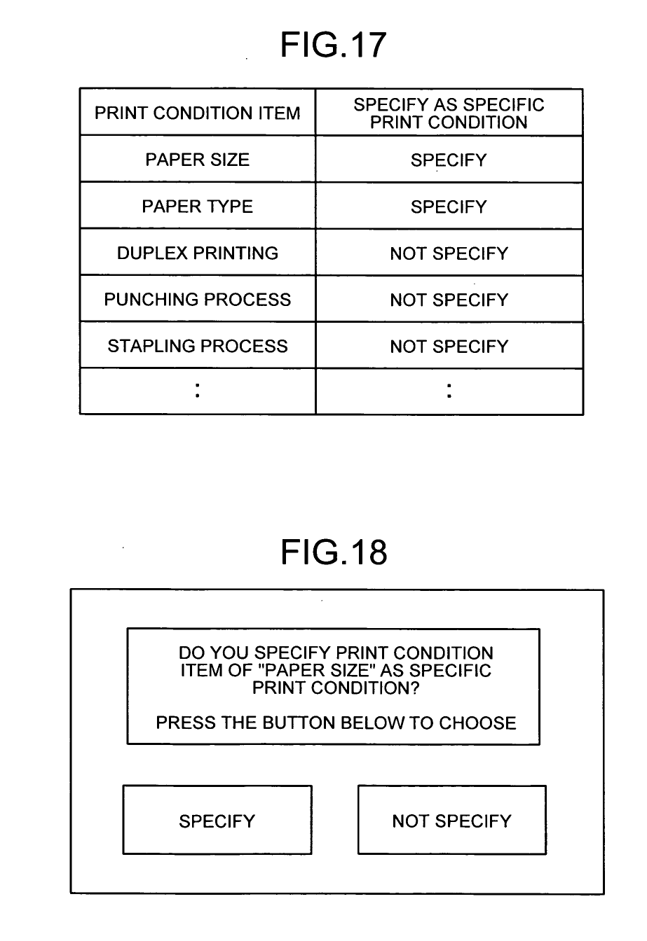

As shown in FIG. 17, the condition-item storage unit 620 stores information as to which of the print condition items is specified as the specific print condition. For example, the condition-item storage unit 620 stores the information such that the item of the paper size is specified as the specific print condition, and the information such that the item of presence or absence of the duplex printing is not specified as the specific print condition.

The storage unit 610 is the storage medium such as HDD and memory, and stores the print data and print condition (before replaced) extracted from the print job data transmitted from the computer. When input of a replaced print condition is accepted from the user, the storage unit 610 stores the replaced print condition. It is noted that when the input of the replaced print condition is accepted from the user, the storage unit 610 stores the print condition before replaced for any print condition item specified by the user as the specific print condition, and stores the replaced print condition for any print condition item other than the specific print condition.

The storage processor 153 interprets the print job data received from the computer via the network, extracts the print condition and the print data from the print job data, and assigns the identification data to the print condition and the print data extracted, making a pair, to be stored in the storage unit 610. Furthermore, when input of a replaced print condition is accepted from the user, the storage processor 153 stores the condition item before replaced, as the print condition, for any print condition item specified as the specific print condition entered through the display input controller 154, in the storage unit 610. And the storage processor 153 stores the condition item after replaced, as the print condition, for any print condition item other than the specific print condition, in the storage unit 610.

The display input controller 154 accepts the specific print condition specified by the user through the operation panel 120, in addition to the functions of the printer according to the first embodiment. As shown in FIG. 18, a screen for the print condition item of, for example, “Paper size” is displayed, and the screen prompts the user to select whether to specify the item as the specific print condition. By pressing the button indicating “Specify”, “Paper size” is specified as the specific print condition, while “Paper size” is not specified as the specific print condition by pressing the button indicating “Not specify”.

The condition-item processor 656 stores the print condition item paired with information on the presence or absence of the specific print condition specified by the user for the relevant print condition item, in the condition-item storage unit 620.

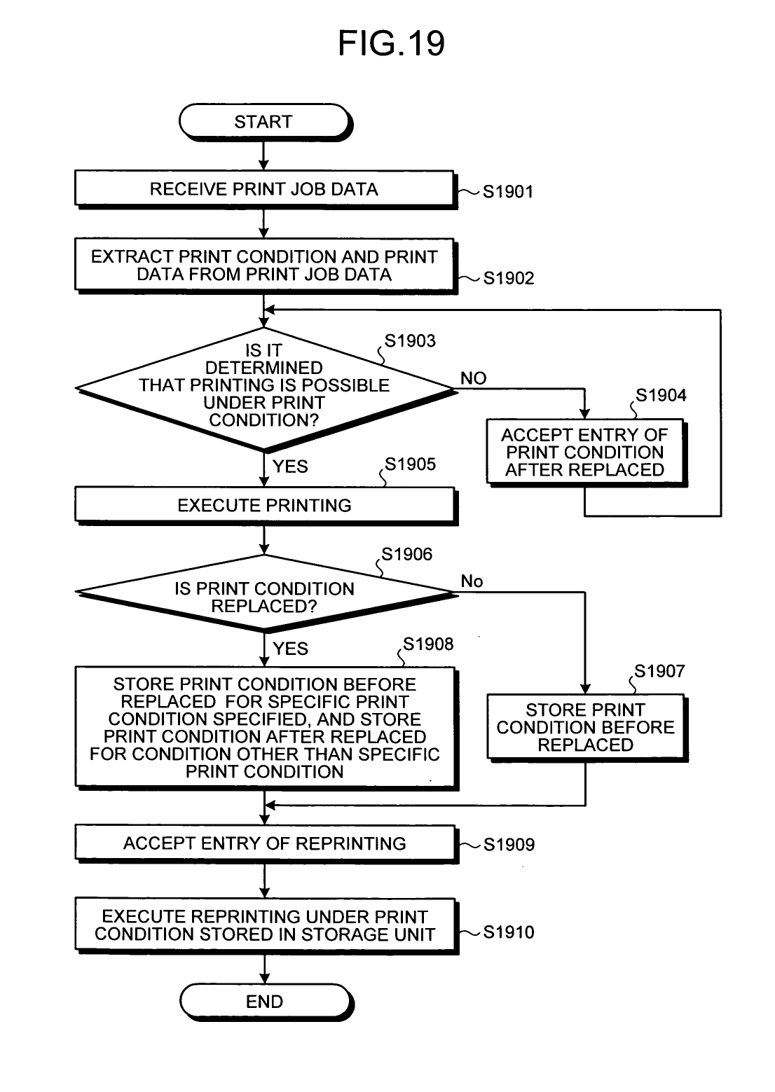

The printing process in the printer according to the sixth embodiment configured in the above manner is explained below with reference to FIG. 19.

First, the reception unit 151 receives the print job data containing the print condition and the print data from the computer via the network I/F 101 (step S1901). Then, the storage processor 153 extracts the print condition and the print data from the print job data received by the reception unit 151 (step S1902). Next, the determination unit 152 determines whether the print data contained in the print job data can be printed under the print condition also contained in the print job data (step S1903).

When it is determined by the determination unit 152 that the print data cannot be printed under the print condition contained in the print job data (step S1903, No), the display input controller 154 displays a message that the printing is impossible on the operation panel 120, and accepts input of a replaced print condition which is changed by the user, through the operation panel 120 (step S1904). The determination unit 152 again determines whether the print data can be printed under the replaced print condition accepted by the display input controller 154 (step S1903).

On the other hand, when it is determined by the determination unit 152 that the print data can be printed under the print condition contained in the print job data or under the replaced print condition entered at step S1904 (step S1903, Yes), the print processor 155 executes the printing process of the print data based on the print condition determined as being printable (step S1905).

The storage processor 153 determines whether the print condition is replaced with another one, that is, determines whether the print processor 155 executes the printing process based on the replaced print condition entered at step S1904 (step S1906). When it is determined that the printing process is not executed based on the replaced print condition (step S1906, No), the storage processor 153 stores the print condition before replaced in the storage unit 610 (step S1907).

On the other hand, when it is determined that the printing process is executed based on the replaced print condition (step S1906, Yes), the storage processor 153 stores the print condition before replaced for any specific print condition specified, and stores the replaced print condition for any condition other than the specific print condition specified (step S1908).

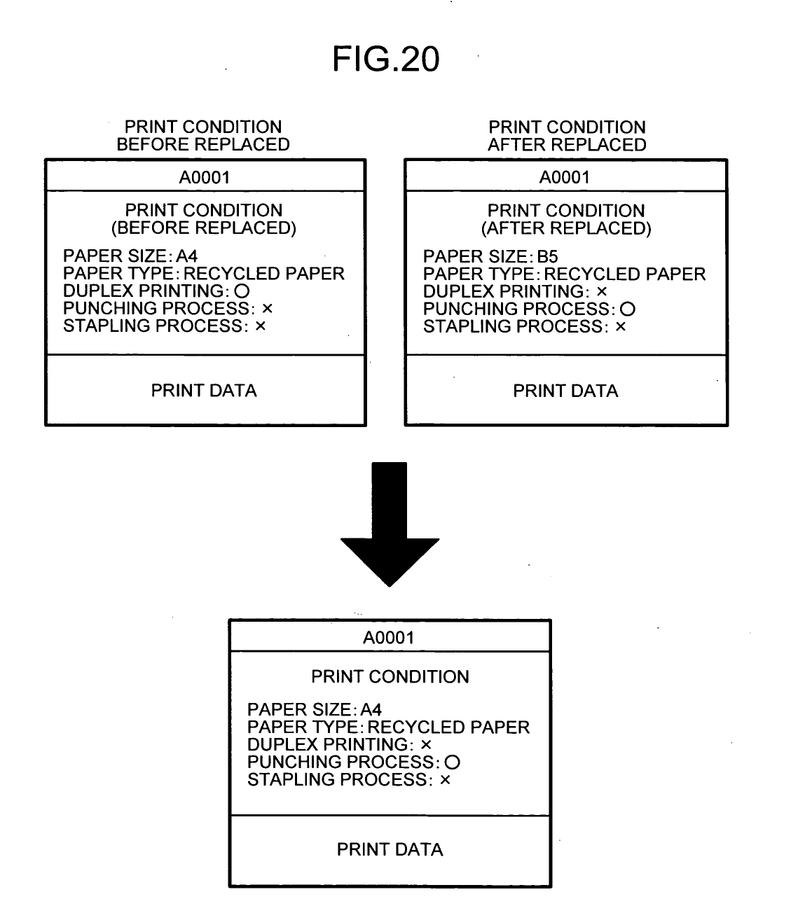

The content of data stored in the storage unit 610 when the printing process is executed based on the replaced print condition is explained below. As shown in FIG. 20, the print condition before replaced indicates the print condition items such as paper size: A4; paper type: recycled paper; duplex printing: available; punching process: not available; and stapling process: not available. Furthermore, the replaced print condition indicates the print condition items such as paper size: B5; paper type: recycled paper; duplex printing: not available; punching process: available; and stapling process: not available.

When the print condition items are stored by referring to FIG. 17, the paper size and the paper type are specified as the specific print condition. Therefore, the print condition before replaced is stored in such a manner as paper size: A4 and paper type: recycled paper. However, the presence or absence of duplex printing, the presence or absence of punching process, and the presence or absence of stapling process are not specified as the specific print condition. Therefore, the replaced print condition is stored in such a manner as duplex printing: not available; punching process: available; and stapling process: not available. It is noted that the specific print condition is previously specified by the user.

When the display input controller 154 accepts input of a reprint request for the print data stored in the storage unit 610 from the user (step S1909), the print processor 155 executes the reprinting process of the print data based on the print condition stored in the storage unit 610 (step S1910).

As explained above, in the printer 600 according to the sixth embodiment, the display input controller 154 accepts the specific print condition specified by the user. When the printing is performed based on the replaced print condition, the storage processor 153 stores the condition item before replaced, as the print condition, for any specific print condition, and stores the condition item after replaced, as the print condition, for any condition item other than the specific print condition. Therefore, even if the printing and storage of the print data are performed concurrently, any condition item for which original print condition is desired to be maintained can be separated from the other condition items. And this feature is added to the setting, and the printing is performed based on this setting, thus reducing the operation by the user and improving the usability. Moreover, by previously specifying the specific print condition, there may be high possibility such that the print condition upon reprinting and the print condition stored match each other, thus, further improving the usability.

Image forming programs executed in the image forming apparatuses according to the first to the sixth embodiments are provided by being previously incorporated in ROM or the like.

The image forming programs executed in the image forming apparatuses according to the first to the sixth embodiments may be provided by being recorded in a computer-readable recording medium in a file with an installable format or with an executable format. Specifically, the recording medium includes Compact Disk Read Only Memory (CD-ROM), flexible disk (FD), CD-Recordable (CD-R), and Digital Versatile Disk (DVD).

The image forming programs executed in the image forming apparatuses according to the first to the sixth embodiments may be provided by being stored in a computer connected to a network such as the Internet and causing the programs to be downloaded via the network. Furthermore, the image forming programs executed in the image forming apparatuses according to the first to the sixth embodiments may be provided or distributed via a network such as the Internet.

The image forming programs executed in the image forming apparatuses according to the first to the sixth embodiments are formed in a module structure including the respective units such as the reception unit, the determination unit, the storage processor, the display input controller, the print processor, the process setting unit, and the condition-item processor. As actual hardware, a Central Processing Unit (CPU) (processor) reads the image forming program from the ROM to execute the program, and the units are thereby loaded on a main storage unit so that the units are generated on the main storage unit.

As described above, according to an embodiment of the present invention, when it is determined that the image based on the image data to be formed cannot be formed and output under the image formation condition, the image formation unit forms and outputs the image based on the image data under the image formation condition after replaced. The storage processor stores the image data and the image formation condition in the storage unit when the image is formed and output. When the image based on the image data stored is to be again formed and output, the image formation unit forms and outputs the image based on the image data, under the image formation condition stored. Therefore, even if the output of the image formed and the storage of the image data are performed concurrently, the image formation condition stored can be used when the image is again formed and output, and this enables improved usability.

Furthermore, according to an embodiment of the present invention, when the image formation unit forms and outputs the image based on the image data under the image formation condition after replaced, the storage processor stores the image formation condition before replaced in the storage unit. Therefore, even if the output of the image formed and the storage of the image data are performed concurrently, the image can be easily formed and output under the image formation condition that is originally desired when the image is again formed and output, and this enables further improved usability.

Moreover, according to an embodiment of the present invention, when the image formation unit forms and outputs the image based on the image data under the image formation condition after replaced, the storage processor stores the image formation condition after replaced in the storage unit. Therefore, even if the output of the image formed and the storage of the image data are performed concurrently, there is no need to replace the image formation condition with another one, the replacement being supposed to be required whenever the condition does not match the device when the image is again formed and output, and this enables further improved usability.

Furthermore, according to an embodiment of the present invention, when the image is formed and output under the image formation condition after replaced, the storage processor stores the image formation condition before replaced and the image formation condition after replaced. When the image based on the image data stored is again formed and output, the display input controller accepts a selection by the user who selects either the image formation condition before replaced or the image formation condition after replaced, under which the image is formed and output. And, the image formation unit forms and outputs the image based on the image data, under the image formation condition before replaced or the image formation condition after replaced selected. Therefore, even if the output of the image formed and the storage of the image data are performed concurrently, the user can select the image formation condition according to the situation when the image is again formed and output, and this enables further improved usability.

Moreover, according to an embodiment of the present invention, when the image is formed and output under the image formation condition after replaced, the storage processor stores the image formation condition before replaced and the image formation condition after replaced. When again forming and outputting the image based on the image data stored, the image formation unit forms and outputs the image under the image formation condition after replaced if the image cannot be formed and output under the image formation condition before replaced. Therefore, even if the output of the image formed and the storage of the image data are performed concurrently, the image can be easily formed and output with a reduced effort of the user when the image is again formed and output, and this enables further improved usability.

Furthermore, according to an embodiment of the present invention, the process setting unit sets either the selected image forming process for forming and outputting the image under the image formation condition selected by the user, or the automatic image forming process for forming and outputting the image under the image formation condition after replaced when the image cannot be formed and output under the image formation condition before replaced. When the image based on the image data is again formed and output, the image formation unit forms and outputs the image under either one of the image formation conditions selected by the user when the selected image forming process is set, and forms and outputs the image under the image formation condition after replaced when the automatic image forming process is set and if the image cannot be formed and output under the image formation condition before replaced. Therefore, even if the output of the image formed and the storage of the image data are performed concurrently, the user can select the image formation condition allowing for the respective advantages of the image formation conditions according to the situation when the image is again formed and output, and this enables further improved usability.

Moreover, according to an embodiment of the present invention, the image formation condition is formed with a plurality of condition items, and when the image is formed and output under the image formation condition after replaced, the storage processor stores the condition item before replaced as the image formation condition, for part of the condition items, and stores the condition item after replaced as the image formation condition, for any condition item other than the part of the condition items. Therefore, even if the output of the image formed and the storage of the image data are performed concurrently, any condition item for which original image formation condition is desired to be maintained can be separated from the other condition items, and the operation by the user can thereby be reduced, and this enables further improved usability.

Furthermore, according to an embodiment of the present invention, the display input controller accepts the part of the condition items specified by the user. Therefore, even if the output of the image formed and the storage of the image data are performed concurrently, by previously setting the condition item, the operation by the user can be reduced when the image is again formed and output, and this enables further improved usability.

Moreover, according to an embodiment of the present invention, in the image forming step, when it is determined that the image based on the image data cannot be formed and output under the image formation condition, the image based on the image data is formed and output under the image formation condition after replaced. In the storage processing step, the image data and the image formation condition are stored in the storage unit when the image is formed and output. In the image forming step, when the image based on the image data stored is to be again formed and output, the image based on the image data is formed and output under the image formation condition stored. Therefore, even if the output of the image formed and the storage of the image data are performed concurrently, the image formation condition stored can be used when the image is again formed and output, and this enables improved usability.

Furthermore, according to an embodiment of the present invention, a computer is caused to execute the image forming method. Therefore, even if the output of the image formed and the storage of the image data are performed concurrently, the image formation condition stored can be used when the image is again formed and output, and this enables improved usability.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a determination unit that determines whether an image formation is possible from input image data under an input image formation condition;
a display input controller that, when it is determined that the image formation is not possible from the image data under the image formation condition by the determination unit, accepts an input of a replaced image formation condition with which the image formation is possible from a display input device;
an image formation unit that, when it is determined that the image formation is not possible from the input image data under the input image formation condition by the determination unit, forms an image from the image data under the replaced image formation condition; and
a storage processor that stores the image data and the image formation condition in a storage unit when the image is formed by the image formation unit, wherein
when reforming an image from stored image data, the image formation unit forms the image under stored image formation condition.

2. The image forming apparatus according to claim 1, wherein
when the image is formed under the replaced image formation condition, the storage processor stores the image formation condition before being replaced in the storage unit.

3. The image forming apparatus according to claim 1, wherein
when the image is formed under the replaced image formation condition, the storage processor stores the replaced image formation condition in the storage unit.

4. The image forming apparatus according to claim 1, wherein
when the image is formed under the replaced image formation condition, the storage processor stores the image formation condition before being replaced and the replaced image formation condition in the storage unit,
when the image is reformed from the stored image data, the display input controller accepts a selection of either one of the image formation condition before being replaced and the replaced image formation condition stored in the storage unit from a user, and
the image formation unit forms the image under selected image formation condition.

5. The image forming apparatus according to claim 1, wherein
when the image is formed under the replaced image formation condition, the storage processor stores the image formation condition before being replaced and the replaced image formation condition in the storage unit,
when the image is reformed from the stored image data, the image formation unit forms the image under stored image formation condition before being replaced, and if the image cannot be formed under the image formation condition before being replaced, forms the image under the replaced image formation condition stored in the storage unit.

6. The image forming apparatus according to claim 1, further comprising:
a process setting unit that, when the image is reformed from stored image data, sets either one of a selected image forming process and an automatic image forming process, wherein
the selected image forming process is for forming the image under the image formation condition selected by a user,
the automatic image forming process is for forming the image under the replaced image formation condition when the image cannot be formed under the image formation condition before being replaced,
when the image is formed under the replaced image formation condition, the storage processor stores the image formation condition before being replaced and the replaced image formation condition in the storage unit,
when the image is reformed from the stored image data, and if the selected image forming process is set, the display input controller accepts a selection of either one of the image formation condition before being replaced and the replaced image formation condition stored in the storage unit from a user, and
when the image is reformed from the stored image data, if the selected image forming process is set, the image formation unit forms the image under selected image formation condition, if the automatic image forming process is set, forms the image under stored image formation condition before being replaced, and if the image cannot be formed under the image formation condition before being replaced, forms the image under the replaced image formation condition stored in the storage unit.

7. The image forming apparatus according to claim 1, wherein
the image formation condition is formed with a plurality of condition items, and
when the image is formed under the replaced image formation condition, the storage processor stores condition items before being replaced as the image formation condition for some of the condition items, and stores replaced condition items as the image formation condition for other of the condition items, in the storage unit.

8. The image forming apparatus according to claim 7, wherein
the display input controller accepts a specification of a part of the condition items by a user, and
the storage processor stores the condition items before being replaced as the image formation condition for specified part of the condition items, and stores the replaced condition items as the image formation condition for condition items other than the specified part of the condition, in the storage unit.

9. An image forming method comprising:
determining whether an image formation is possible from input image data under an input image formation condition;
accepting, when it is determined that the image formation is not possible from the image data under the image formation condition at the determining, an input of a replaced image formation condition with which the image formation is possible from a display input device;
forming, when it is determined that the image formation is not possible from the input image data under the input image formation condition at the determining, an image from the image data under the replaced image formation condition; and
storing the image data and the image formation condition in a storage unit when the image is formed at the forming, wherein
when reforming an image from stored image data, the forming includes forming the image under stored image formation condition.

10. A computer program product comprising a computer usable medium having computer readable program codes embodied in the medium that when executed cause a computer to execute:
determining whether an image formation is possible from input image data under an input image formation condition;
accepting, when it is determined that the image formation is not possible from the image data under the image formation condition at the determining, an input of a replaced image formation condition with which the image formation is possible from a display input device;
forming, when it is determined that the image formation is not possible from the input image data under the input image formation condition at the determining, an image from the image data under the replaced image formation condition; and
storing the image data and the image formation condition in a storage unit when the image is formed at the forming, wherein
when reforming an image from stored image data, the forming includes forming the image under stored image formation condition.
